(19) United States
(12) Patent Application Publication
(10) Pub. No.: US 2021/0254670 A1
(43) Pub. Date: Aug. 19, 2021

(54) Pulley decoupler having press-fit teeth and auxiliary unit drive and drive motor comprising such a pulley decoupler

(71) Applicant: Schaeffler Technologies AG & Co. KG, Herzogenaurach (DE)

(72) Inventors: Dimitri Sieber, Ettlingen (DE); Patrick Antusch, Baden-Baden (DE); Andreas Stuffer, Weingarten (DE)

(73) Assignee: Schaeffler Technologies AG & Co. KG, Herzogenaurach (DE)

(21) Appl. No.: 17/251,261

(22) PCT Filed: Jun. 6, 2019
(86) PCT No.: PCT/DE2019/100510

§ 371 Date: Dec. 11, 2020

(30) Foreign Application Priority Data
Jul. 3, 2018 (DE) 10 2018 116 028.3

(51) Int. Cl. F16D 1/072; F16F 15/12; F16H 55/36

(52) U.S. Cl. CPC F16D 1/072; F16H 2055/366; F16H 55/36; F16F 15/1203

(57) ABSTRACT

A pulley decoupler for an auxiliary unit drive, comprising:
an input part comprising a hub;
an output part comprising a pulley, wherein the output part and the input part are rotatable about a common axis of rotation; and
a flange which is connected to the hub or the pulley by press-fit teeth.

An auxiliary unit drive and a drive motor having a corresponding pulley decoupler are provided.

### CROSS-REFERENCE TO RELATED APPLICATIONS

This application is the U.S. National Phase of PCT Appln. No. PCT/DE2019/100510 filed Jun. 6, 2019, which claims priority to DE 102018116028.3 filed Jul. 3, 2018, the entire disclosures of which are incorporated by reference herein.

### TECHNICAL FIELD

The present disclosure relates to a pulley decoupler for an auxiliary unit drive, in particular a drive motor of a motor vehicle. In particular, a traction means of the auxiliary unit drive can be driven by means of the pulley decoupler. The disclosure also relates to an auxiliary unit drive and a drive motor comprising such a pulley decoupler.

### BACKGROUND

Such pulley decouplers regularly have a damping device having at least one spring accumulator, which serves to reduce torsional vibrations and is arranged between an input part and an output part of the pulley decoupler. The input part regularly comprises a hub which can be coupled in a rotationally fixed manner to a shaft of a drive motor so as to introduce torque. The torque can be transmitted to the output part via the hub, a flange and the damping device. The output part regularly comprises a pulley having a traction means running surface, wherein the torque can be transferred to the traction means as a tensile force via the pulley. To transmit the torque, the individual components of the pulley decoupler are connected to one another with form-fitting and/or force-fitting connections. For example, this can be by screwing, riveting, pinning or pressing. However, these types of connection are not always suitable for the transmission of very high torques or a sufficiently large installation space is not available.

### SUMMARY

The object of the disclosure is therefore to at least partially solve the problems described with reference to the prior art and in particular to provide a pulley decoupler with which high torques can be transmitted and which requires a small installation space. In addition, an auxiliary unit drive and a drive motor having a pulley decoupler should be provided, wherein high torques should be transmittable by the pulley decoupler and wherein the pulley decoupler requires a small installation space.

These objects are achieved with a pulley decoupler, auxiliary unit drive and a drive motor according to the features of the embodiments described herein and in the claims. Further advantageous embodiments of the disclosure are specified in the claims and following description. It should be pointed out that the features listed individually in the claims can be combined with one another in any technologically expedient manner and define further refinements of the embodiments disclosed herein. In addition, the features indicated in the claims are specified and explained in more detail in the description, in which further preferred embodiments are described.

A pulley decoupler for an auxiliary unit drive having at least the following components contributes hereto:
an input part comprising a hub;
an output part comprising a pulley, wherein the output part and the input part can rotate about a common axis of rotation; and
a flange which is connected to the hub or the pulley by means of press-fit teeth.

A pulley decoupler can be a driving wheel of an auxiliary unit drive or a driven wheel of an auxiliary unit drive. Such an auxiliary unit drive serves in particular to drive at least one auxiliary unit of a drive motor or motor vehicle. An auxiliary unit can be an auxiliary machine of the motor vehicle that does not contribute or does not contribute directly to its motion. The auxiliary machine can be, for example, an electric motor, a generator, a pump or a fan. The pulley decoupler can in particular transmit a torque of the drive motor to the at least one auxiliary unit via at least one traction means. For this purpose, an input part of the pulley decoupler can be coupled to the drive motor in such a way that the input part can be driven by the drive motor about an axis of rotation. For this purpose, the input part has a hub which can be connected to a shaft of the drive motor in a rotationally fixed manner. The shaft can be, for example, a crankshaft, balancer shaft, intermediate shaft, or camshaft. The input part is coupled to an output part so that the output part can be rotated about the axis of rotation with the input part.

The output part has a traction means running surface for the at least one traction means. The traction means running surface is in particular formed on a circumferential surface of a pulley of the output part so that torque can be transmitted as tensile force to the at least one traction means. The designations input part and output part refer to a torque flow direction in which the pulley decoupler is a driving wheel that can be driven by the drive motor, which can be an internal combustion engine or an electric motor, for example. However, the pulley decoupler can also be a wheel driven by the traction means, which serves to drive an auxiliary unit.

The pulley decoupler also has a flange which is connected to the hub or the pulley by means of press-fit teeth. The flange is in particular a sheet metal component. Furthermore, the flange is designed in particular to be annular. The flange can be rotated about the axis of rotation with the input part and/or the output part. In particular, the torque can be transmitted from the hub to the pulley via the flange. For this purpose, the flange is connected to the hub and/or the pulley by means of the press-fit teeth in a torsion-proof manner. To produce the press-fit teeth, for example, the flange with a toothing can be pressed onto the hub and/or the pulley. The toothing cuts into the hub and/or the pulley so that a torsion-proof connection is created. The toothing on the hub and/or the pulley is therefore only created during the joining process by axially pressing the flange onto the hub and/or pulley. This can mean that a plastic deformation of the hub and/or the pulley occurs during the manufacture of the press-fit teeth. This can result in chips, for example. These displaced chips can be brought shot and/or closed into a (closed) chip chamber. The hub can have an extension in the axial direction on which the flange can be placed before the manufacture of the press-fit teeth. As a result, the flange can be centered in particular with respect to the hub. In addition, the extension can have a third diameter which is in particular smaller than a first diameter of the press-fit teeth and/or smaller than a second diameter of a collar of the hub. Due to the press-fit teeth, no additional components or a higher cost of materials are required for connecting the flange to the hub and/or the pulley. Furthermore, very high torques can be transmitted via the press-fit teeth. The press-fit teeth also do not require any additional installation space.

The pulley decoupler can have a spring device, by means of which the output part and the input part can rotate to a limited extent relative to one another about the common axis of rotation. The spring device having at least one energy store can be effective between the input part and the output part, so that the output part and the input part can rotate to a limited extent relative to one another. The spring device can be supported on the input part and the output part. The at least one energy store is in particular at least one compression spring, at least one spiral spring, at least one elastic element and/or at least one arc spring. The at least one energy store is arranged in particular on the flange, in particular on an outer circumference of the flange, wherein the flange can rotate about the axis of rotation. The at least one energy store is supported on the one hand on the flange and on the other hand on the pulley, so that the torque can be transmitted to the pulley of the pulley decoupler via the hub, the spring flange and the at least one energy store. The spring device can rotate the input part and the output part relative to one another against a spring force of the spring device. Rotational vibrations or torsional vibrations can in particular be damped and/or eliminated by the spring device.

For further damping or elimination of the rotational vibrations or torsional vibrations, the pulley decoupler can have a centrifugal pendulum device. The centrifugal pendulum device has a centrifugal pendulum flange which is rotatable about the axis of rotation and has at least one pendulum mass which can be displaced under the action of centrifugal force with respect to the centrifugal pendulum flange. Furthermore, the centrifugal pendulum flange can have at least two pendulum masses. For example, the centrifugal pendulum flange can have two, three, or four pendulum masses. The at least one pendulum mass can be displaceable along a predetermined path. In addition, the at least one pendulum mass can be displaceable between a first end position and a second end position. The centrifugal pendulum device can be used for speed-adaptive damping and/or elimination of the rotational vibrations or torsional vibrations.

The centrifugal pendulum device can be arranged on the input part or the output part. In this way, adapted in each case to the application, an improvement of the damping and/or elimination of the rotational vibrations or torsional vibrations is possible. Furthermore, installation space optimization adapted to the application is possible.

The press-fit teeth can be formed on an inner circumference of the flange.

The press-fit teeth can have a first diameter that is smaller than a second diameter of a collar of the hub. The first diameter is in particular an inside diameter of the flange. The collar of the hub is, in particular, the area of the hub onto which the flange is pressed during the manufacture of the press-fit teeth. The second diameter is in particular an outer diameter of the collar. Since the first diameter is smaller than the second diameter, a plastic deformation of the flange and/or the hub occurs during the manufacture of the press-fit teeth.

The press-fit teeth can be cut into the hub. This means in particular that the hub is plastically deformed during the manufacture of the press-fit teeth.

The pulley decoupler can have a chip chamber for chips produced during the manufacture of the press-fit teeth. The chip chamber is, in particular, an annular space into which the chips produced during the manufacture of the press-fit teeth can enter. The chip chamber can be opened in an axial direction, in particular before the flange is attached to the hub. After the manufacture of the press-fit teeth or the attachment of the flange to the hub, the flange can in particular close the chip chamber. As a result, the chips collected in the chip chamber can no longer escape from the chip chamber.

The chip chamber can be designed to be annular.

The flange can have a greater hardness than the hub. This can ensure that during the manufacture of the press-fit teeth only the hub and/or the pulley are (substantially) (plastically) deformed.

According to a further embodiment of the disclosure, an auxiliary unit drive having at least one traction means is also proposed, wherein the traction means at least partially wrap around at least one pulley decoupler.

According to yet another embodiment of the disclosure, a drive motor for a motor vehicle is also proposed, wherein a shaft of the drive motor is coupled to a pulley decoupler.

With regard to further details of the auxiliary unit drive and/or the drive motor, reference is made to the description of the pulley decoupler according to the disclosure.

### BRIEF DESCRIPTION OF THE DRAWINGS

Both the embodiments of the disclosure and the technical field are explained in more detail below using the figures. It should be noted that the figures show a particularly preferred variant of the embodiments of the disclosure, but is not limited thereto. Like components are provided with the same reference numerals in the figures. In an exemplary and schematic manner:

FIG. 1: shows a drive motor having a pulley decoupler in a side view;

FIG. 2: shows a known pulley decoupler in longitudinal section;

FIG. 3: shows a pulley decoupler according to the disclosure in longitudinal section;

FIG. 4: shows a flange of the pulley decoupler in a front view;

FIG. 5: shows the flange after press-fitting with a hub of the pulley decoupler; and

FIG. 6: shows a detailed view of the flange after press-fitting with the hub of the pulley decoupler.

### DETAILED DESCRIPTION

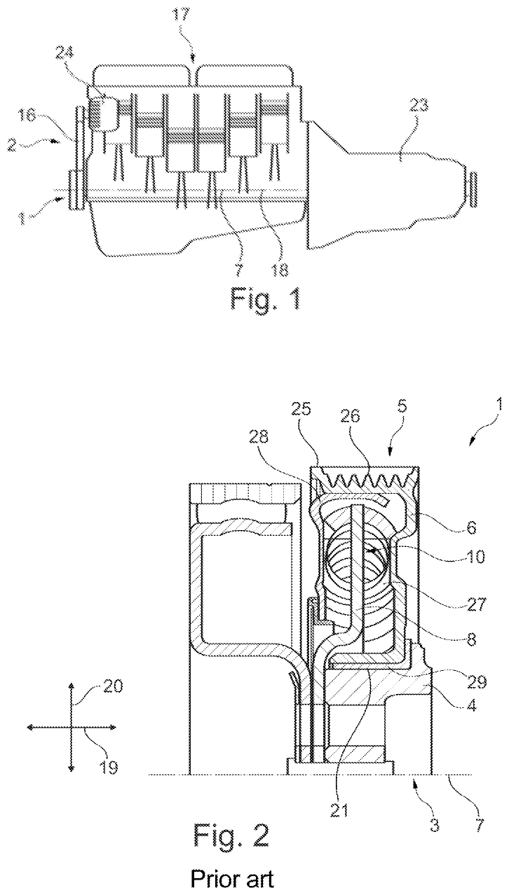

FIG. 1 shows a drive motor 17 having an auxiliary unit drive 2 in a side view. The auxiliary unit drive 2 comprises a pulley decoupler 1, which is connected to a shaft 18 of the drive motor 17. Here, the shaft 18 is a crankshaft of the drive motor 17. The pulley decoupler 1 can be rotated about an axis of rotation 7 by means of the shaft 18. On a side of the drive motor 17 opposite the pulley decoupler 1, the shaft 18 is coupled to a transmission 23. An auxiliary unit 24 can be driven by the pulley decoupler 1 via a traction means 16. The auxiliary unit 24 is a (current) generator, for example in the style of an alternator.

FIG. 2 shows a known pulley decoupler 1 in a longitudinal section, which can be part of an auxiliary unit drive 2 shown in FIG. 1. The pulley decoupler 1 has an input part 3 having a hub 4 and a flange 8. The hub 4 and the flange 8 are designed to be connected in a torsion-proof manner to one another, wherein the hub 4 can be connected to the shaft 18 of the drive motor 17 shown in FIG. 1, by means of which the hub 4 and the flange 8 can be rotated about the common axis of rotation 7. The pulley decoupler 1 also has an output part 5 having a pulley 6. A traction means running surface 26 for the traction means 16 of the auxiliary unit drive 2 shown in FIG. 1 is formed on an outer surface 25 of the pulley 6. Between the input part 2 and the output part 4, a spring device 10 is provided with a plurality of energy stores 27 distributed in a circumferential direction, wherein the energy stores 27 here are designed in the form of arc springs. The energy stores 27 are supported on the one hand on the flange 8 and on the other hand on the pulley 6 or a cover 28 of the pulley 6, so that the input part 3 and the output part 5 can rotate to a limited extent relative to one another against a spring force of the energy stores 27. The cover 28 is pressed into the pulley 6 in a torsion-proof manner relative to the pulley 6. The pulley 6 can be rotated to a limited extent about the axis of rotation 7 relative to the hub 4. For this purpose, a sliding bearing 29 is arranged on a circumferential surface 21 of the hub 4. The sliding bearing 29 supports the pulley 6 in an axial direction 19 (parallel to the axis of rotation 7) and a radial direction 20 (orthogonal to the axial direction 19) with respect to the hub 4.

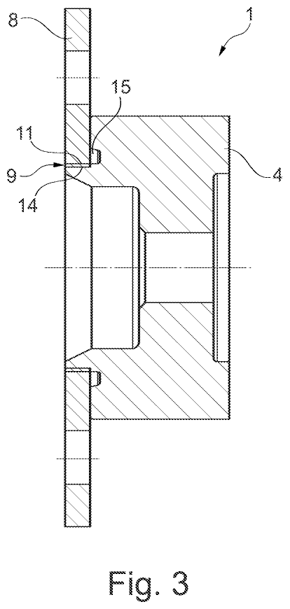

FIG. 3 shows a pulley decoupler 1 according to the disclosure in longitudinal section. In this case, the flange 8 is connected in a torsion-proof manner to the hub 4 by means of press-fit teeth 9. The press-fit teeth 9 are formed on an inner circumference 11 of the flange 8 and an outer collar 14 of the hub 4. In FIG. 3, the pulley decoupler 1 is shown only with the hub 4 and the flange 8 for the sake of simplicity. Apart from the press-fit teeth 9, the pulley decoupler 1 can also be designed, in particular, like the known pulley decoupler 1 shown in FIG. 2.

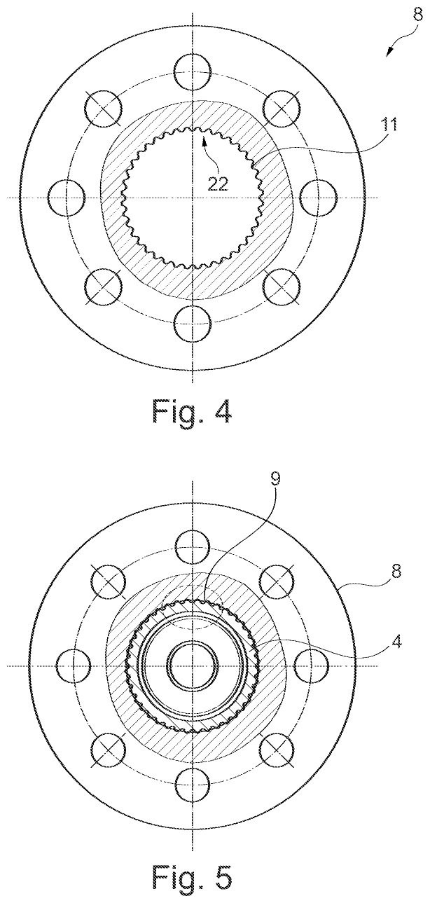

FIG. 4 shows the flange 8 in a partial section and in a front view. A toothing 22 of the flange 8 can be seen here on the inner circumference 11 of the flange 8 before press-fitting with the hub 4 shown in FIG. 3.

FIG. 5 shows the flange 8 after press-fitting with the hub 4. The press-fit teeth 9 were cut into the hub 4 by the toothing 22 shown in FIG. 4 during the press-fitting of the flange 8 with the hub 4. The chips produced in the process can be received by an annular chip chamber 15 shown in FIG. 3.

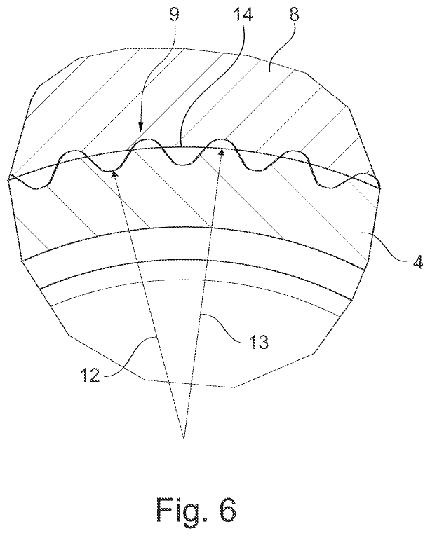

FIG. 6 shows a detailed view of the region of the flange 8 marked in FIG. 5 after press-fitting with the hub 4. The press-fit teeth 9 have a first diameter 12 that is smaller than a second diameter 13 of the collar 14 of the hub 4.

As a result of the present disclosure, a pulley decoupler 1 can be operated in a particularly reliable manner and can be manufactured more cost-effectively.

### LIST OF REFERENCE NUMBERS

Pulley decoupler

Auxiliary unit drive

Input part

Hub

Output part

Pulley

Axis of rotation

Flange

Press-fit teeth

Spring device

Inner circumference

First diameter

Second diameter

Collar

Chip chamber

Traction means

Drive motor

Shaft

Axial direction

Radial direction

Circumferential surface

Toothing

Transmission

Auxiliary unit

Exterior surface

Traction means running surface

Energy store

Cover

Sliding bearing

1. A pulley decoupler for an auxiliary unit drive, comprising:
an input part comprising a hub;
an output part comprising a pulley, wherein the output part and the input part are rotatable about a common axis of rotation; and
a flange which is connected to the hub or the pulley by press-fit teeth.

2. The pulley decoupler according to claim 1, according to claim 1, further comprising a spring device, by which the output part and the input part are rotatable to a limited extent relative to one another about the common axis of rotation.

3. The pulley decoupler according to claim 1, wherein the press-fit teeth are formed on an inner circumference of the flange.

4. The pulley decoupler according to claim 1, wherein the press-fit teeth have a first diameter which is smaller than a second diameter of a collar of the hub.

5. The pulley decoupler according to claim 1, wherein the press-fit teeth are cut into the hub.

6. The pulley decoupler according to claim 1, further comprising a chip chamber for chips produced during a manufacture of the press-fit teeth.

7. The pulley decoupler according to claim 6, wherein the chip chamber is designed to be annular.

8. The pulley decoupler according to claim 1, wherein the flange has a greater hardness than the hub.

9. An auxiliary unit drive having at least one traction means, wherein the traction means at least partially wrap around at least one pulley decoupler according to claim 1.

10. A drive motor for a motor vehicle, wherein a shaft of the drive motor is coupled to a pulley decoupler according to claim 1.
